(19) United States
(12) Patent Application Publication
(10) Pub. No.: US 2025/0320083 A1
(43) Pub. Date: Oct. 16, 2025

(54) WIRE REEL

(71) Applicant: Faraday Factory Japan LLC, Tokyo (JP)

(72) Inventors: Ilia MATVIIAN, Tokyo (JP); Alexei LI, Tokyo (JP); Valentin CHEREMIN, Tokyo (JP)

(21) Appl. No.: 18/738,739

(22) Filed: Jun. 10, 2024

(30) Foreign Application Priority Data
Apr. 15, 2024 (JP) 2024-065524

(51) Int. Cl. B65H 75/22; B65H 75/28

(52) U.S. Cl. CPC B65H 75/22; B65H 75/28; B65H 2701/36

(57) ABSTRACT

The present invention relates to a wire reel 1 provided with a winding drum 21 around which a superconducting wire Lis wound, a first flange plate 22 and a second flange plate 23 located at axial ends of the winding drum 21, a first member 11 integrally formed of the first flange plate 22 and a first winding drum-forming portion 24 constituting one half portion of the winding drum 21, and a second member 12 integrally formed of the second flange plate 23 and a second winding drum-forming portion 25 constituting the other half portion of the winding drum 21.

### CROSS-REFERENCE TO RELATED APPLICATIONS

The present application is based on Japanese patent application No. 2024-65524 filed on Apr. 15, 2024, the entire contents of which are incorporated herein by reference.

### TECHNICAL FIELD

This invention relates to a wire reel.

### BACKGROUND OF THE INVENTION

As a wire reel for winding superconducting wires, there is a wire reel equipped with a winding core on which a superconducting wire is wound and a pair of side plates joined to both axial ends of the winding core (see Patent Literature 1). This wire reel has the pair of side plates to prevent the superconducting wire wound on the winding core from coming off the winding core.

Citation List Patent Literature 1: JP2021-11375A

### SUMMARY OF THE INVENTION

However, in this type of wire reel, the winding core and the pair of side plates are individually formed, and the wire reel is assembled by fastening them to each other, which makes the assembly work complicated and increases the number of parts. Further, dies for manufacturing wire reels must be prepared for each component, resulting in high manufacturing costs.

Therefore, an object of the present invention is to provide a wire reel that can be easily assembled and the number of parts can be reduced. Further, another object of the present invention is to provide a wire reel for which the number of dies for the manufacturing process can be reduced.

According to one embodiment of the present invention is a wire reel comprising a winding drum around which a superconducting wire is wound, a first flange plate and a second flange plate located at axial ends of the winding drum, a first member integrally formed of the first flange plate and a first winding drum-forming portion constituting one half portion of the winding drum, and a second member integrally formed of the second flange plate and a second winding drum-forming portion constituting an other half portion of the winding drum.

### Advantageous Effects of the Invention

According to one embodiment of the invention, it is possible to provide a wire reel that can be easily assembled and the number of parts can be reduced. Further, according to one embodiment of the invention, it is possible to provide a wire reel for which the number of dies for the manufacturing process can be reduced.

### BRIEF DESCRIPTION OF DRAWINGS

FIG. 1 is a perspective view of a wire reel according to one embodiment of the invention.

FIG. 2 is a front view of the wire reel.

FIG. 3 is a side view of the wire reel.

FIG. 4 is an exploded view of the wire reel.

FIG. 5 is a front view of a first member.

FIG. 6 is a right side view of the first member.

FIG. 7 is a left side view of the first member.

FIG. 8 is a cross-sectional view of the wire reel, cut along the A-A′ line of FIG. 3.

FIG. 9 is a cross-sectional view of the wire reel, cut along the B-B′ line of FIG. 3.

FIG. 10 is a front view of a second member.

FIG. 11 is a right side view of the second member.

FIG. 12 is a left side view of the second member.

FIG. 13 is the first explanatory diagram showing an assembly method of the wire reel.

FIG. 14 is the second explanatory diagram showing the assembly method of the wire reel.

FIG. 15 is the third explanatory diagram showing the assembly method of the wire reel.

FIG. 16 is the first explanatory diagram showing a method of winding a superconducting wire on a wire reel.

FIG. 17 is the second explanatory diagram showing the method of winding a superconducting wire on a wire reel.

FIG. 18 is the third explanatory diagram showing the method of winding a superconducting wire on a wire reel.

### DETAILED DESCRIPTION OF THE INVENTION

Next, a wire reel according to one embodiment of the invention will be explained with reference to the accompanying drawings. This wire reel is configured in such a manner that a tape-like superconducting wire is wound around and can be rolled out. In particular, this wire reel is composed of two components to improve assembly and reduce the number of parts. As shown in the respective drawings, the left and right (X1, X2), front and back (Y1, Y2), and upper and lower (Z1, Z2) are defined for the explanation.

### Configuration of a Wire Reel

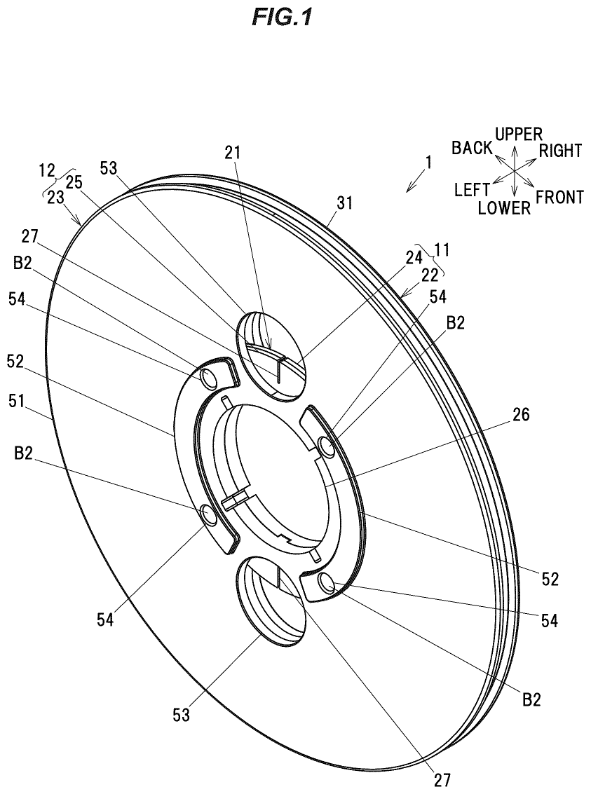

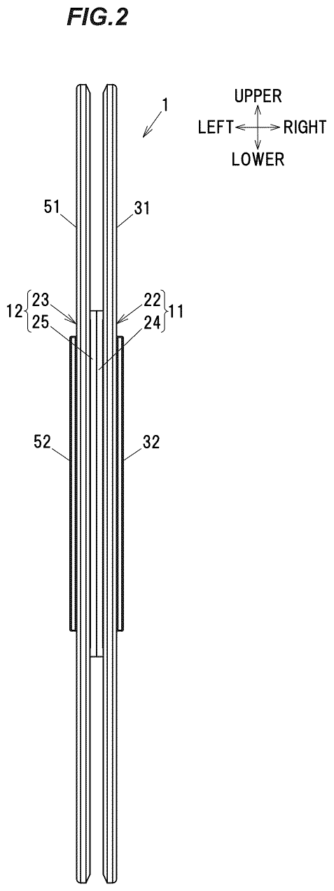

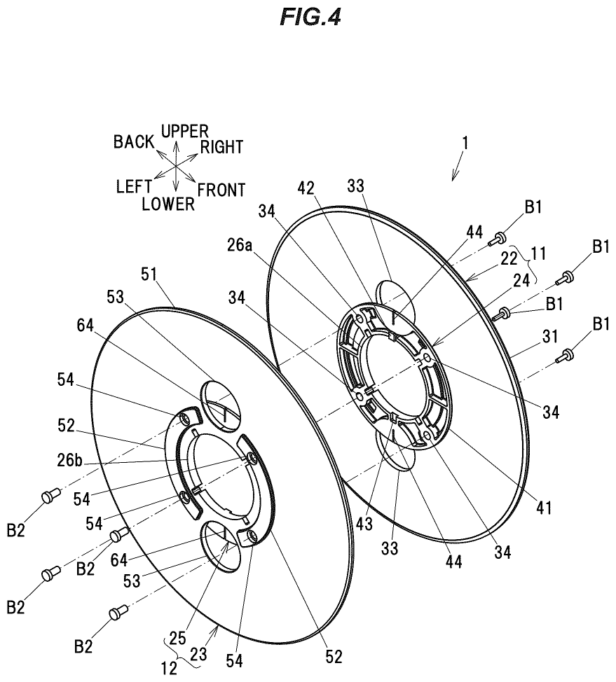

As shown in FIGS. 1 to 4, a wire reel 1 is a reel member consisting of a winding drum 21 around which a superconducting wire L is wound, a right flange plate 22 and a left flange plate 23 located at both axial ends of the winding drum 21, a first member 11 on the right side that is integrally (i.e., as a single piece) formed of the right flange plate 22 and a first winding drum-forming portion 24 constituting one half portion of the winding drum 21, and a second member 12 on the left side that is integrally formed of the left flange plate 23 and a second winding drum-forming portion 24 constituting another half portion of the winding drum 21. In other words, the wire reel 1 is composed of two members, the first member 11 and the second member 12. The right flange plate 22 is an example of a first flange plate, and the left flange plate 23 is an example of a second flange plate.

The superconducting wire L is a tape-like material made by forming respective layers, including a superconducting layer, on a lengthy substrate. There are three main types of superconducting wires L: 4 mm wide, 6 mm wide, and 12 mm wide. In the present embodiment, a 4 mm wide superconducting wire L is wound around the wire reel 1. In other words, the wire reel 1 in the present embodiment is a wire reel 1 for 4 mm wide superconducting wire L.

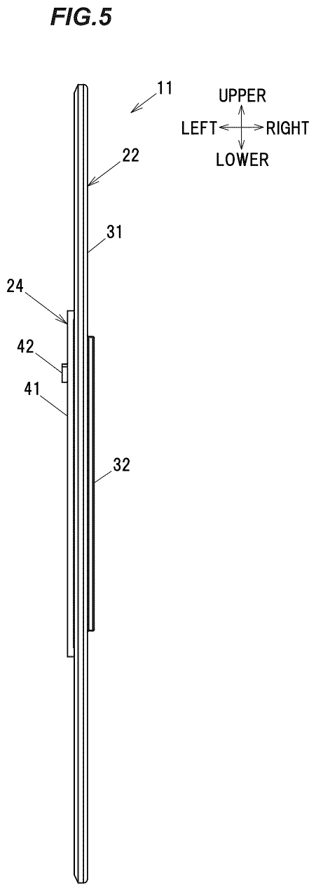

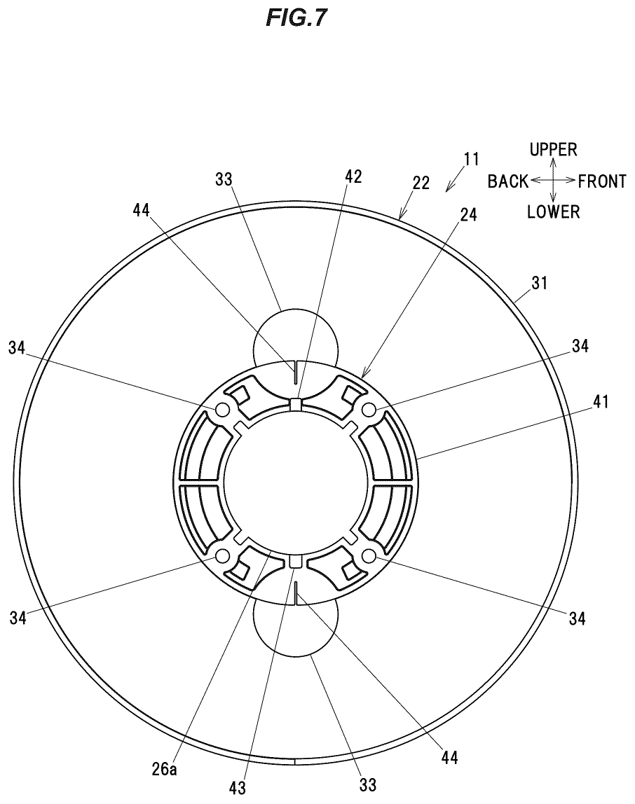

As shown in FIGS. 5 to 7, the first member 11 is formed by injection molding of a resin material, and the right flange plate 22 and the first winding drum-forming portion 24 are coaxially formed in one piece. A hole 26a, which forms one half of a shaft hole 26, is formed in the center of the first member 11. The first member 11 is preferably transparent or translucent so that the state of the superconducting wire L wound around the winding drum 21 can be checked.

The right flange plate 22 has a right flange plate main body 31 formed in the shape of a disk, two front and back arcuate protrusions 32 protruding from the right side of the right flange plate main body 31, and two upper and lower operation holes 33 opened in the right flange plate main body 31. The details of the operation holes 33 are described below. The right flange plate main body 31 has a thickness of 2.8 mm to 3.2mm (preferably 3 mm) in order to increase the strength of the entire wire reel 1. The gate mark made when the first member 11 is injection molded is preferably formed on the right face of the right flange plate main body 31.

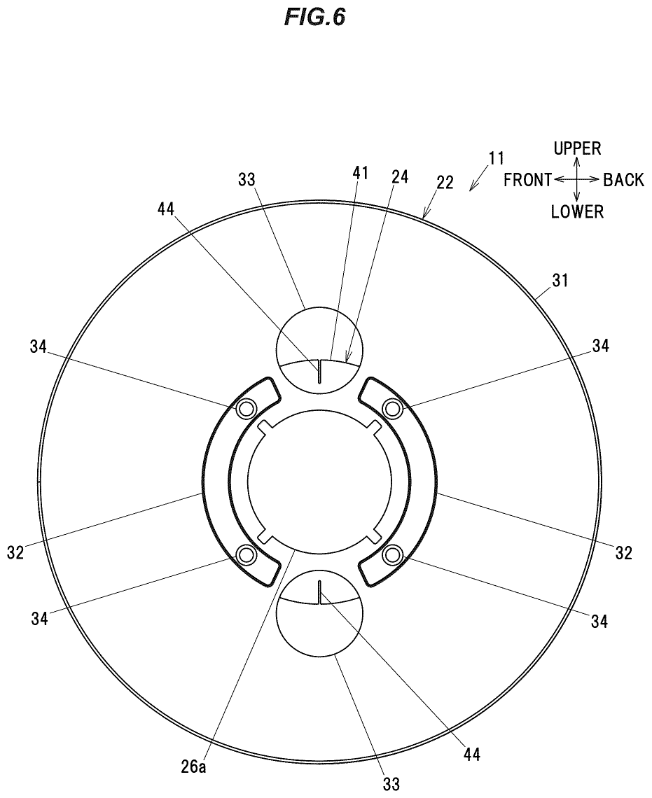

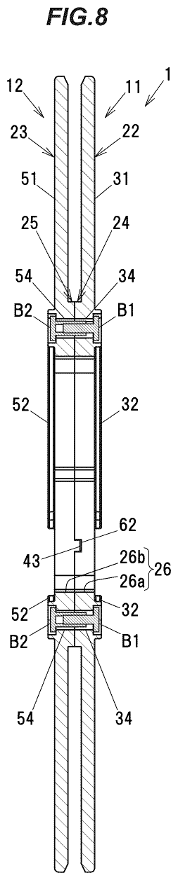

Each arcuate protrusion 32 protrudes in the right direction from the right face of the right flange plate main body 31 and is formed extending in an arcuate shape along a circumferential direction of the right flange plate main body 31. As shown in FIGS. 6 and 8, two holes (through-holes) 34 each are formed at the position of each arcuate protrusion 32 for passing through fastening screws B1 and B2. In other words, each arcuate protrusion 32 functions as a counterbore to prevent a head of the fastening screw B1 from going out (protruding). Each arcuate protrusion 32 protruding in the right direction from the right face of the right flange plate main body 31 also functions as a spacer to form a space between two wire reels 1 when a plurality of wire reels 1 are stacked or lined up. In other words, the arcuate protrusion 32 is an example of a spacer protruding from the opposite side of the winding drum 21. The thickness (height in the left-right direction) of each arcuate protrusion 52 is, e.g., 2.5 mm.

As shown in FIGS. 5, 7, and 9, the first winding drum-forming portion 24 has a winding drum-forming portion main body 41 formed in the shape of a disk, an engaging convex portion 42 convexed on an upper part of the left face of the winding drum-forming portion main body 41, an engaging concave portion 43 concaved on a lower part of the left face of the winding drum-forming portion main body 41, and two upper and lower grooves 44, 44 that form the halves of a slit 27, as described below, and are formed on the winding drum-forming portion main body 41. The second member 12 is temporarily fixed to the first member 11 by engaging the engaging convex portion 42 of the first member 11 with the engaging concave portion 63 of the second member 12 and engaging the engaging convex portion 62 of the second member 12 with the engaging concave portion 43 of the first member 11, as will be described in detail later.

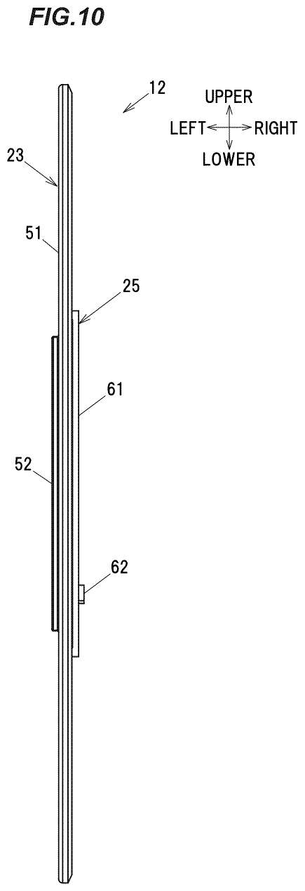

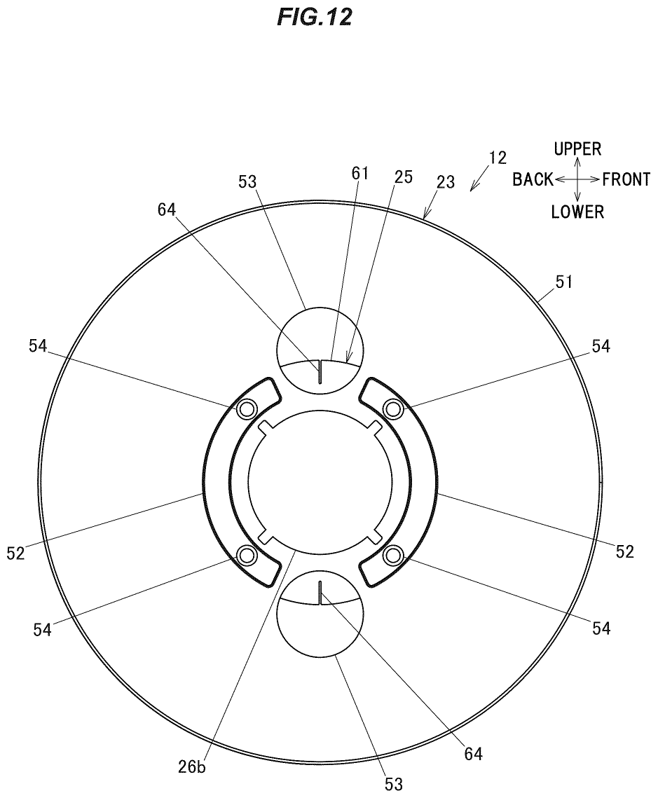

As shown in FIGS. 10 to 12, the second member 12 is formed by injection molding of a resin material, and the left flange plate 23 and the second winding drum-forming portion 25 are coaxially formed in one piece. A hole 26b, which forms the other half of the shaft hole 26, is formed in the center of the second member 12. The second member 12 is preferably transparent or translucent so that the state of the superconducting wire L wound around the winding drum 21 can be checked.

The left flange plate 23 has a left flange plate main body 51 formed in the shape of a disk, two front and back arcuate protrusions 52 protruding from the left side of the left flange plate main body 51, and two upper and lower operation holes 53 opened in the left flange plate main body 51. The details of the operation holes 53 are described below. The left flange plate main body 51 has a thickness of 2.8 mm to 3.2 mm (preferably 3 mm) in order to increase the strength of the entire wire reel 1. The gate mark made when the second member 12 is injection molded is preferably formed on the left face of the left flange plate main body 51.

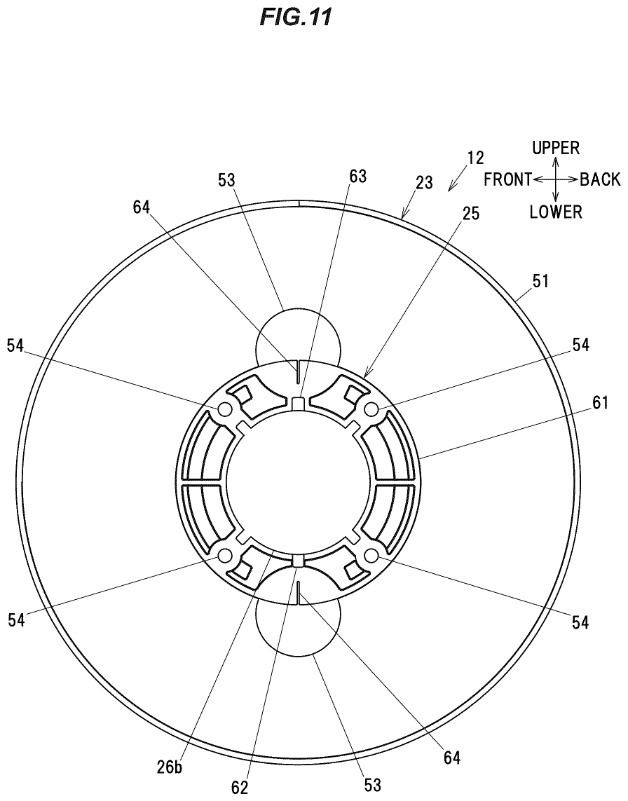

Each arcuate protrusion 52 protrudes in the left direction from the left face of the left flange plate main body 51 and is formed extending in an arcuate shape along a circumferential direction of the left flange plate main body 51. As shown in FIGS. 8 and 11, two holes (through-holes) 54 each are formed at the position of each arcuate protrusion 52 for passing through fastening screws B1 and B2. In other words, each arcuate protrusion 52 functions as a counterbore to prevent a head of the fastening screw B2 from going out (protruding). Each arcuate protrusion 52 protruding in the left direction from the left face of the left flange plate main body 51 also functions as a spacer to form a space between two wire reels 1 when a plurality of wire reels 1 are stacked or lined up. In other words, the arcuate protrusion 52 is an example of a spacer protruding from the opposite side of the winding drum 21. The thickness (height in the left-right direction) of each arcuate protrusion 52 is, e.g., 2.5 mm.

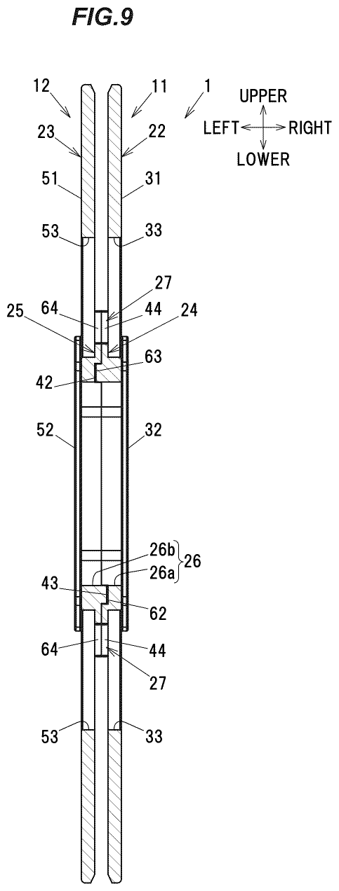

As shown in FIGS. 9, 10, and 12, the second winding drum-forming portion 25 has a winding drum-forming portion main body 61 formed in the shape of a disk, an engaging convex portion 62 convexed on a lower part of the right face of the winding drum-forming portion main body 61, an engaging concave portion 63 concaved on an upper part of the right face of the winding drum-forming portion main body 61, and two upper and lower grooves 64, 64 that form the halves of the slit 27, as described below, and are formed on the winding drum-forming portion main body 61. The second member 12 is temporarily fixed to the first member 11 by engaging the engaging convex portion 42 of the first member 11 with the engaging concave portion 63 of the second member 12 and engaging the engaging convex portion 62 of the second member 12 with the engaging concave portion 43 of the first member 11.

### Method of Manufacturing a Wire Reel

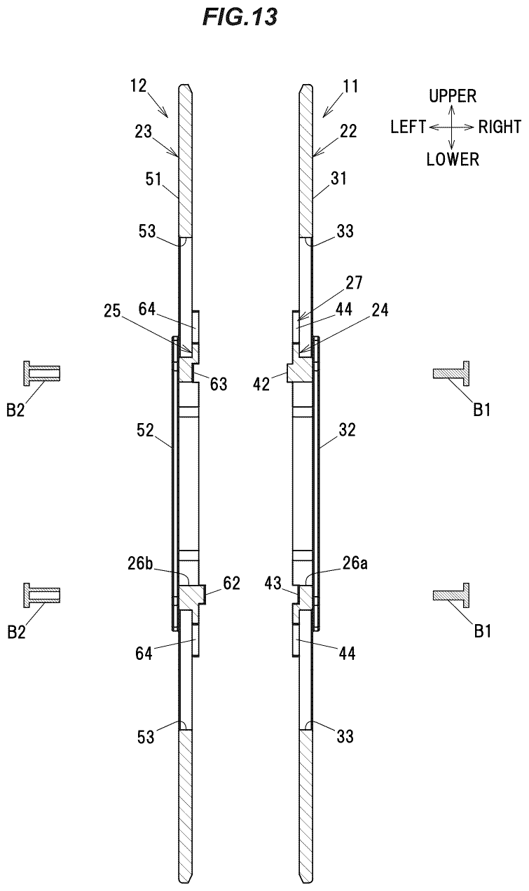

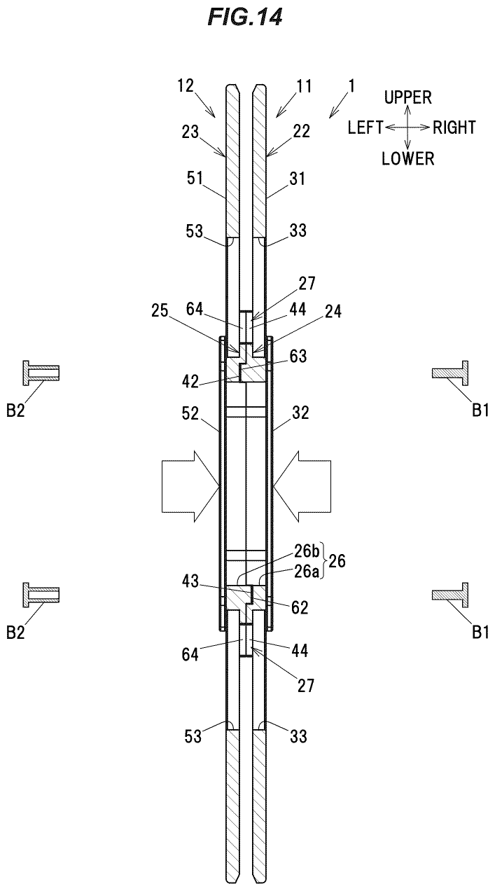

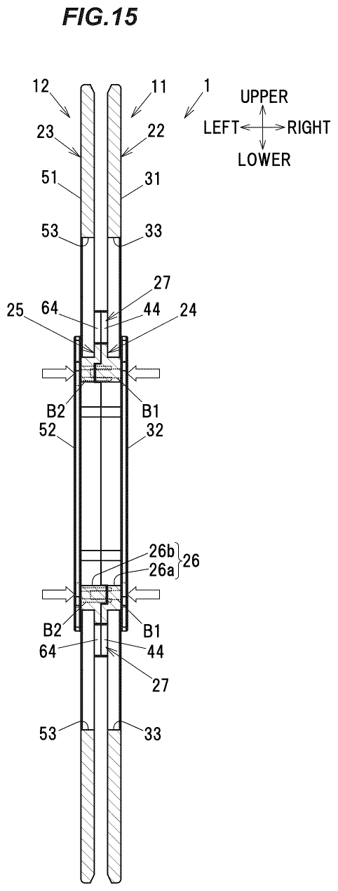

Next, a method of manufacturing a wire reel according to one embodiment of the invention will be described. As described above, the first member 11 and the second member 12 constituting the wire reel 1 have the same shape when rotated 180 degrees from each other, and can be molded by injection molding or the like of a material such as resin using the same mold. The wire reel 1 is manufactured by preparing the first member 11 and the second member 12 molded from the same mold and assembling the first member 11 and second member 12. As shown in FIGS. 13 to 15, assembly of the wire reel 1 is performed by fastening the second member 12 to the first member 11 by the fastening screws B1 and B2 while the second member 12 is temporarily fixed to the first member 11. In detail, as shown in FIG. 14, the second member 12 is first temporarily fixed to the first member 11 by engaging the engaging convex portion 42 of the first member 11 to the engaging concave portion 63 of the second member 12 and engaging the engaging convex portion 62 of the second member 12 to the engaging concave portion 43 of the first member 11. As a result, the second member 12 is positionally fixed to the first member 11 in the circumferential direction, the upper and lower (vertical) direction, and the front and back direction. Then, as shown in FIG. 15, the second member 12 is fastened (screwed) to the first member 11 by the fastening screws B1 and B2. As a result, the wire reel 1 is assembled.

When the second member 12 is fastened to the first member 11 and the wire reel 1 is assembled, the winding drum 21 is formed by the first winding drum-forming portion 24 of the first member 11 and the second winding drum-forming portion 25 of the second member 12, and the shaft hole 26 is formed by the hole 26a of the first member 11 and the hole 26b of the second member 12. The dimensions of the gap between the right flange plate 22 and the left flange plate 23 are adjusted to match the width of the superconducting wire L (slightly larger than the width of the superconducting wire L).

In the winding drum 21 formed by the first winding drum-forming portion 24 and the second winding drum-forming portion 25, the two upper and lower slits 27 are formed by the grooves 44 of the first member 11 and the grooves 64 of the second member 12. The slits 27 are mounting holes for attaching the end of the superconducting wires L, and have dimensions that allow the end of the superconducting wires L to be inserted.

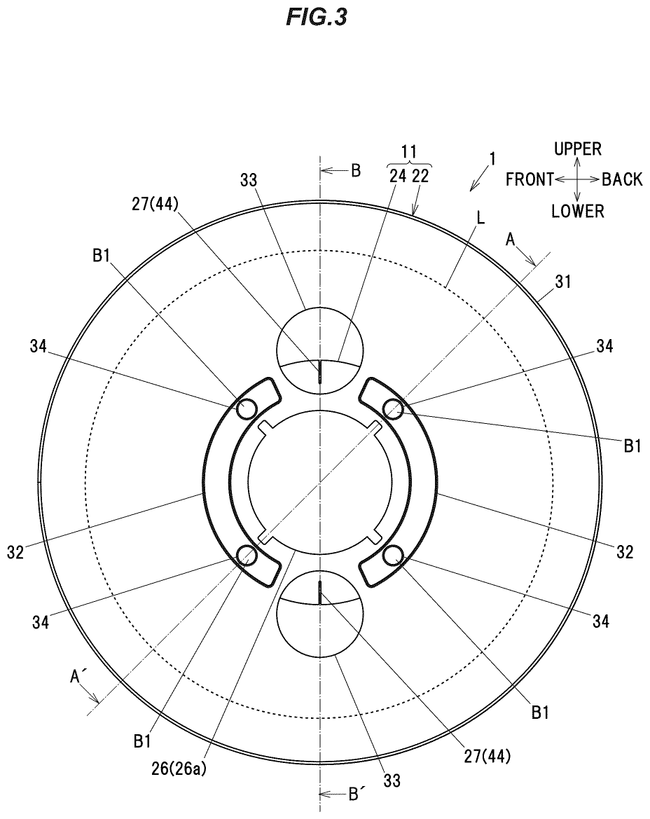

As shown in FIGS. 1 and 3, each of the operation holes 33 and 53 is an opening for inserting the end of the superconducting wire L into the slit 27, and is circular and formed at a position facing the edge of the slit 27. The size of each of the operation holes 33 and 53 is determined in such a manner that a thumb F1 and an index finger F2 of the operator can be inserted simultaneously, and preferably be at least 46 mm in diameter. Such operation holes 33 and 53 allow the operator to directly grasp the end of the superconducting wire L with the thumb F1 and index finger F2 and insert it into the slit 27.

### Method of Winding a Superconducting Wire on a Wire Reel

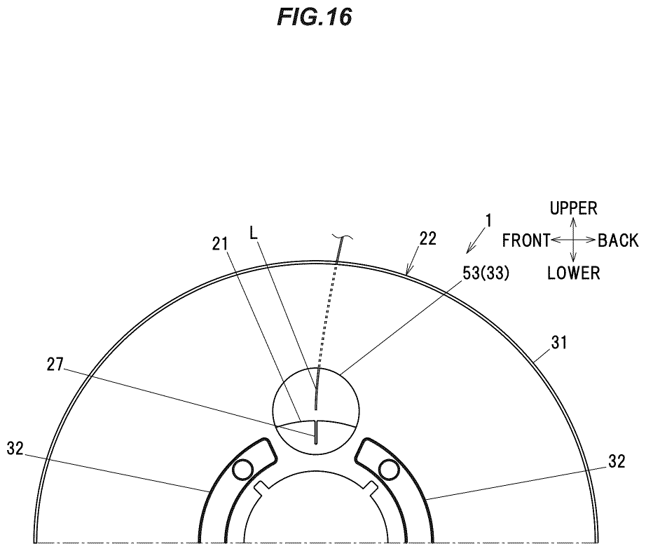

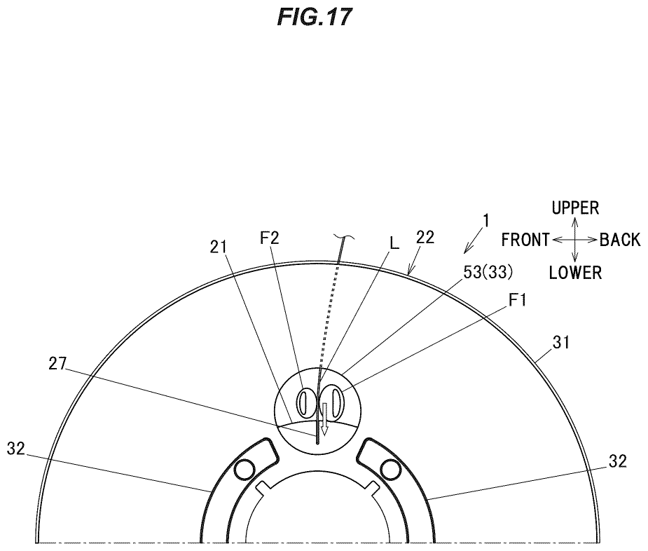

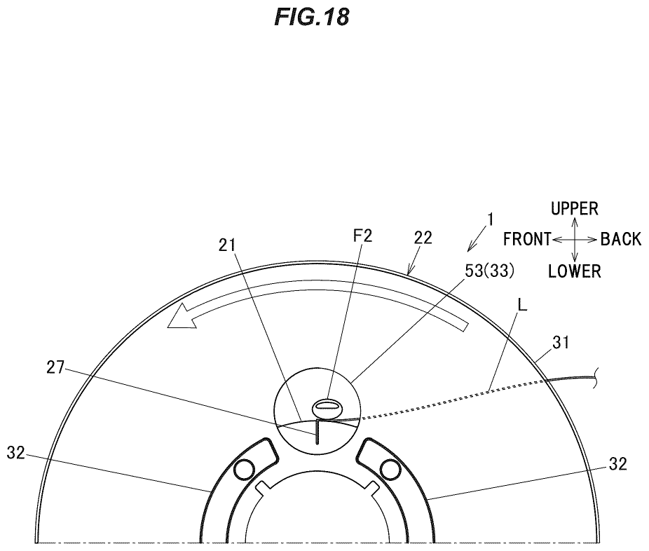

When winding the superconducting wire L around the wire reel 1, first, as shown in FIG. 16, the tip of the superconducting wire L is placed between the right flange plate 22 and the left flange plate 23, and the tip is moved to the position of the operation holes 33 and 53. Next, as shown in FIG. 17, the thumb F1 and index finger F2 are inserted through the operation holes 33 and 53, to directly grasp the tip of the superconducting wire L and insert the tip into the slit 27. Then, as shown in FIG. 18, the front side of the portion of the superconducting wire L inserted into the slit 27 is pressed against the winding drum 21 with the index finger F2, and the wire reel 1 is rotated by a winding device or the like. This causes the superconducting wire L to be wound around the wire reel 1.

### Function and Effect of the Embodiment

According to the configuration of the above embodiment, the wire reel 1 is consisted of two members, i.e., the first member 11 and the second member 12, so that the wire reel 1 can be assembled simply by fastening the two members to each other, making assembly work easy. In addition, the number of parts can be reduced compared to the configuration in which the winding drum 21, the right flange plate 22, and the left flange plate 23 are individually formed, and the cost of making the wire reel 1 can be reduced. In addition, since custom-made fastening screws B1 and B2 are not required to fasten the first member 11 and the second member 12, and ready-made fastening screws B1 and B2 can be used, the wire reel 1 can be made at a lower cost. Furthermore, since the first member 11 and the second member 12 are integrally formed of the flange plates 22 and 23 and the winding drum-forming portions 24 and 25, the flange plates 22 and 23 can be assembled without making mistakes, even by unskilled operators, since they cannot be assembled in the opposite directions.

Further, the first member 11 and the second member 12 have the same shape, which allows the first member 11 and the second member 12 to be made using the same mold, further reducing the cost of making the wire reel 1.

In the right flange plate 22 and the left flange plate 23, the operation holes 33 and 53 facing the edge of the slit 27 are formed so that the end of the superconducting wire L can be directly grasped and inserted into the slit 27, and the end of the superconducting wire L can be easily inserted into the slit 27. In addition, since the front side of the portion of the superconducting wire L inserted into the slit 27 can be pressed against the winding drum 21 with the index finger F2, it is possible to prevent the end of the superconducting wire L from falling out of the slit 27 when the wire reel 1 is rotated.

In addition, the operation holes 33 and 53 are formed in both the right flange plate 22 and the left flange plate 23, which makes it easier to operate the end of the superconducting wire L and to insert the end of the superconducting wire L more easily into the slit 27.

In addition, the formation of the engaging convex portions 42 and 62 and the engaging concave portions 43 and 63 in the first winding drum-forming portion 24 and the second winding drum-forming portion 25 enables temporary fixing of the second member 12 to the first member 11. This eliminates the need to align the threaded holes 34 and 54 when fastening with the fastening screws B1 and B2, which are the main fixing, and allows easy fastening with the fastening screws B1 and B2.

Further, the arcuate protrusions 32 and 52 on the right flange plate 22 and the left flange plate 23 can form a space between multiple wire reels 1 when they are stacked or lined up (i.e., stored side by side). This allows one wire reel 1 to be easily taken out from a plurality of wire reels 1 stacked or lined up. In addition, since a space can be formed between the right flange plate main body 31 of one wire reel 1 and the left flange plate main body 51 of another wire reel 1, it is possible to suppress damage to the flange plate main bodies 31 and 51 and/or the superconducting wire L due to contact between the flange plate main bodies 31 and 51.

### For Other Embodiments

The above described embodiment does not limit the invention claimed in the claims. It should also be noted that not all of the combinations of features described in the embodiment are essential to the means for solving the problems of the invention. The present invention can be implemented with appropriate modifications to the extent that it does not depart from the gist of the invention.

In the above embodiment, each of the operation holes 33 and 53 has a circular shape, but the shape of each of the operation holes 33 and 53 is not limited to this as long as the operator's fingers can enter the operation hole 33 or 53. For example, the shape of each of the operation holes 33 and 53 may be a square, a polygon other than a square, or an oval or ellipse.

In the above embodiment, the invention was applied to a wire reel 1 for a 4 mm wide superconducting wire L, wherein the gap between the right flange plate 22 and the left flange plate 23 is matched to a 4 mm wide superconducting wire L. However, the invention may also be applied to a wire reel 1 for a 6 mm wide superconducting wire L, wherein the gap between the gap between the right flange plate 22 and the left flange plate 23 is matched to a 6 mm wide superconducting wire L. The invention may also be applied to a wire reel 1 for a 12 mm wide superconducting wire L, where the gap between the gap between the right flange plate 22 and the left flange plate 23 is matched to a 12 mm wide superconducting wire L.

In the above embodiment, the invention was applied to the wire reel 1, but the invention may also be applied to a reel-wound wire provided with a superconducting wire L and a wire reel 1 with the superconducting wire L wound around it. In the above embodiment, the invention was applied to the wire reel 1 for superconducting wire, but the invention may also be applied to a wire reel for a tape-like wire other than the superconducting wire, a composite tape which is fragile to the impact, and the like.

If a technology that does not use a mold, such as a 3D printer, is used to mold the first member 11 and the second member 12, a configuration in which the first member 11 and the second member 12 have different shapes in some parts can be adopted. For example, in the above embodiment, the winding drum 21 has a configuration in which two slits 27 are formed and two operation holes 33 and 53 are formed at the top and bottom of each of the right flange plate 22 and the left flange plate 23, respectively, while in the winding drum 21, only one slit 27 is formed and operation holes 33 and 53 are formed at the top and bottom of each of the right flange plate 22 and the left flange plate 23. However, in the winding drum 21, only one slit 27 may be formed, and in each of the right flange plate 22 and the left flange plate 23, only one operation hole 33 or 53 may be formed.

In the above embodiment, the configuration is that the operation holes 33 and 53 are formed in both the right flange plate 22 and the left flange plate 23, but the configuration may be that the operation holes 33 and 53 are formed in only one of the right flange plate 22 and the left flange plate 23.

In the above embodiment, both the first winding drum-forming portion 24 and the second winding drum-forming portion 25 have the engaging convex portions 42 and 62, and both the first winding drum-forming portion 24 and the second winding drum-forming portion 25 have the engaging concave portions 43 and 63 that engage the engaging convex portions 42 and 62. However, it is also possible to have a configuration in which the engaging convex portions 42 and 62 are formed on only one of the first winding drum-forming portion 24 and the second winding drum-forming portion 25, and the engaging concave portions 43 and 63 are formed on only the other of the first winding drum-forming portion 24 and the second winding drum-forming portion 25.

### Summary of Embodiments

Next, the technical concepts that can be grasped from the embodiment described above will be described with the aid of the reference numerals, etc. in the embodiment. However, each reference numerals, etc. in the following description is not limited to the members, etc. specifically shown in the embodiment as the constituent elements in the scope of claims.

According to the first feature, a wire reel 1 includes a winding drum 21 around which a superconducting wire L is wound, a first flange plate 22 and a second flange plate 23 located at axial ends of the winding drum 21, a first member 11 integrally formed of the first flange plate 22 and a first winding drum-forming portion 24 constituting one half portion of the winding drum 21, and a second member 12 integrally formed of the second flange plate 23 and a second winding drum-forming portion 25 constituting the other half portion of the winding drum 21.

According to the second feature, in the wire reel 1 as described by the first feature, the first member 11 and the second member 12 have the same shape.

According to the third feature, in the wire reel 1 as described by the first or second feature, the winding drum 21 has a slit 27 for attaching an end of the superconducting wire L, and at least one of the first flange plate 22 and the second flange plate 23 has an operation hole 33, 53 facing the slit 27.

According to the fourth feature, in the wire reel 1 as described by any one of the first to third features, one of the first winding drum-forming portion 24 and the second winding drum-forming portion 25 has an engaging convex portion 42, 62, and the other of the first winding drum-forming portion 24 and the second winding drum-forming portion 25 has an engaging concave portion 43, 63 that engages an engaging convex portion 42, 62.

According to the fifth feature, in the wire reel 1 as described by any one of the first to fourth feature, each of the first flange plate 22 and the second flange plate 23 has a spacer 32, 52 protruding from a face opposite to the winding drum 21.

### Industrial Applicability

The present invention can provide a wire reel that can be easily assembled and the number of parts can be reduced. The invention can be applied to a wire reel for superconducting wire, and a wire reel for a tape-like wire other than the superconducting wire, a composite tape which is fragile to the impact, and the like.

1. A wire reel, comprising:
a winding drum around which a superconducting wire is wound;
a first flange plate and a second flange plate located at axial ends of the winding drum;
a first member integrally formed of the first flange plate and a first winding drum-forming portion constituting one half portion of the winding drum; and
a second member integrally formed of the second flange plate and a second winding drum-forming portion constituting an other half portion of the winding drum.

2. The wire reel, according to claim 1, wherein the first member and the second member have a same shape.

3. The wire reel, according to claim 1, wherein the winding drum includes a slit for attaching an end of the superconducting wire, and at least one of the first flange plate and the second flange plate includes an operation hole facing the slit.

4. The wire reel, according to claim 2, wherein the winding drum includes a slit for attaching an end of the superconducting wire, and at least one of the first flange plate and the second flange plate includes an operation hole facing the slit.

5. The wire reel, according to claim 1, wherein one of the first winding drum-forming portion and the second winding drum-forming portion includes an engaging convex portion, and wherein an other of the first winding drum-forming portion and the second winding drum-forming portion includes an engaging concave portion that engages an engaging convex portion.

6. The wire reel, according to claim 2, wherein one of the first winding drum-forming portion and the second winding drum-forming portion includes an engaging convex portion, and wherein an other of the first winding drum-forming portion and the second winding drum-forming portion includes an engaging concave portion that engages an engaging convex portion.

7. The wire reel, according to claim 1, wherein each of the first flange plate and the second flange plate includes a spacer protruding from a face opposite to the winding drum.

8. The wire reel, according to claim 2, wherein each of the first flange plate and the second flange plate includes a spacer protruding from a face opposite to the winding drum.
